(19) United States
(12) Patent Application Publication
(10) Pub. No.: US 2008/0275612 A1
(43) Pub. Date: Nov. 6, 2008

(54) Shift Control Method for an Automatic Gearbox

(75) Inventor: Andelko Vesenjak, Meckenbeuren (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 12/095,808

(22) PCT Filed: Nov. 17, 2006
(86) PCT No.: PCT/EP2006/011043

§ 371 Date: Jun. 2, 2008

(30) Foreign Application Priority Data
Dec. 3, 2005 (DE) 10 2005 057 809.8

(51) Int. Cl. F02D 41/04; G06F 19/00

(52) U.S. Cl. 701/54

(57) ABSTRACT

A method of shift control for an automated vehicle transmission which is connected to an engine by an automated clutch. The internal combustion engine includes a controllable fuel injection such that, during a gear shift from a gear under load to a target gear, before the loaded gear is disengaged, the torque of the engine is adjusted to an idling torque by modifying the fuel injection amount and, after the target gear has been engaged, to a load torque by a converse modification of the injection amount. At the beginning of the shift, at least one operating parameter, characterizing the vehicle's current operating condition, and/or a shift parameter, characterizing the desired shift operation, is detected and evaluated to adjust the shift to the operating situation. A fuel injection amount of the engine, associated with the idling torque, is variably adapted to the vehicle's operating condition and/or the shift operation depending on the evaluation.

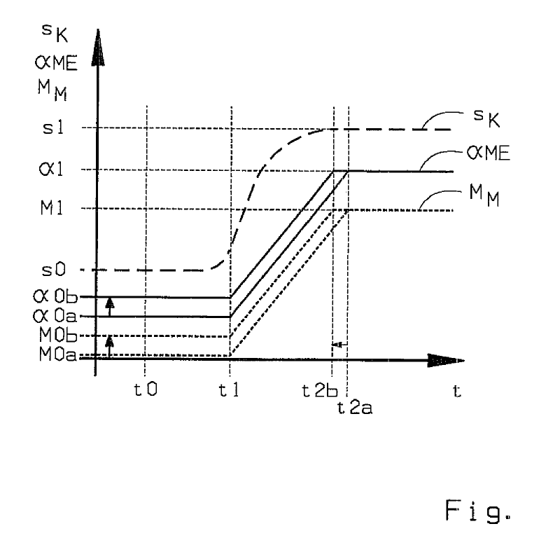

This application is a national stage completion of PCT/EP2006/011043 filed Nov. 17, 2006, which claims priority from German Application Serial No. 10 2005 057 809.8 filed Dec. 3, 2005.

### FIELD OF THE INVENTION

The invention concerns a shift control method for an automated motor vehicle transmission, which is connected on its input side to a drive engine by an engine clutch made as an automated friction clutch. The engine is an internal combustion engine provided with controllable fuel injection, such that during a gearshift, between a gear under load and a target gear, before the loaded gear is disengaged the torque of the drive engine is adjusted to an idling torque by a modification of the amount of fuel injected and, after the target gear has been engaged, to a load torque by a converse modification of the injection amount.

### BACKGROUND OF THE INVENTION

Automated transmissions are increasingly used in motor vehicles for both passenger cars and commercial vehicles, while having relatively low weight, compact dimensions and high transmission efficiency, owing to their automated shift operations, they offer a high level of operating comfort and reduce the fuel consumption of the motor vehicle concerned. A range of automated transmissions for commercial vehicles is described in ATZ9/2004 from page 772 onwards under the title “The ZF-AS-Tronic Family”.

In a modern drive train provided with an automated transmission, the engine clutch and the drive engine are connected by control means to the transmission so that, during a shift operation, besides the automated disengagement and engagement of the engine clutch during the gear change, the torque and speed of the drive engine are also adapted by appropriate control means, as a rule both being reduced. A number of possibilities are available for doing this, depending on the structural features of the drive engine and the specific sequence during the shift process.

In DE 197 15 850 A1, it is known to reduce the torque and speed during a shift operation in an automated transmission by at least partially closing an exhaust gas throttle valve, by delaying the ignition time, by reducing the delivery power of a fuel pump or the quantity injected by injection valves and/or by at least partially closing an intake throttle valve.

In DE 199 04 129 C1, it is proposed that during a shift operation of this type the torque reduction of the drive engine, before the engine clutch is disengaged should be used to make the transmission load free from the disengagement of the loaded gear. In contrast, DE 102 43 277 A1 describes a shift control method for an automated transmission in which a shift process takes place with the engine clutch engaged and a mechanical engine brake is used for synchronization of the target gear.

In the present case the starting point is an integrally controllable drive train of the type described above in which, during a shift operation, before the gear under load is disengaged, the torque of the drive engine is adjusted to an idling torque in essence by modifying the amount of fuel injected, i.e., for a traction shift reduced by decreasing the amount injected and for a thrust shift increased by increasing the amount injected and in which, once the target gear has been engaged, the torque of the drive engine is readjusted to the required load torque by a converse modification of the amount injected, i.e., for a traction shift increased by increasing the amount injected and for a thrust shift reduced by decreasing the amount injected.

The shift operation concerned can be carried out both with a disengaged and an engaged engine clutch. The drive train is freed from load during the shift process in the first case, essentially by disengaging the engine clutch and, in the second case, (in the absence of other auxiliary means) by setting a corresponding idling torque.

Such a control method of the shift operation, by virtue of the amount of fuel injected, is preferably used with motor vehicles having diesel engines, in particular commercial vehicles, but it can also be used with motor vehicles having gas engines, in particular when the latter comprise direct gasoline injection. For controlling the amount injected, until now the amount injected appropriate for the idling torque has been taken as a constant value, but in certain operating situations such as a traction upshift while driving uphill with a heavy load, this can lead to unfavorable shifting behavior in relation to shift duration, clutch wear and shift comfort.

Against this background, the purpose of the present invention is to propose a shift control method for an automated transmission of the type mentioned to begin with, which is better adapted to the operating situation at the time.

This objective is achieved such that, at the beginning of the shift operation, at least one operating parameter that characterizes the current operating condition of the motor vehicle and/or a shift parameter that characterizes the shift operation envisaged is detected and evaluated. The drive engine injection amount associated with the idling torque is adapted variably to the operating condition of the motor vehicle and/or to the shift operation in accordance with the result of the evaluation.

### SUMMARY OF THE INVENTION

By adjusting the injection amount associated with the idling torque according to the invention, the torque and speed of the drive engine are increased or reduced, depending on the control direction, and are thereby adapted to the operating condition of the motor vehicle at the time and/or to the shift operation itself envisaged, whereby the shift operation is either accelerated or can take place with less wear and more comfortably.

The current operating condition of the motor vehicle is determined inter alia by the driving resistance at the time, which can expediently be determined in order to adapt the injection amount of the drive engine associated with the idling torque in relation to an average driving resistance, in the case of higher driving resistance by increasing, and in the case of a lower driving resistance by reducing the amount.

During steady-state driving the driving resistance is a combination of rolling resistance, air resistance and road inclination resistance. The rolling resistance increases in proportion to the weight of the vehicle, the air resistance increases proportionally to the square of the driving speed and the inclination resistance proportionally to vehicle weight and road inclination. Thus, the laden weight of the motor vehicle can be determined by a load sensor and from this and the known unladen weight the rolling resistance can be calculated.

With a speed sensor, usually present in the form of a rotation speed sensor arranged on the transmission output shaft, the driving speed can be determined and from it the air resistance calculated. The road inclination can be measured by an inclination sensor and from it, together with the previously determined driving speed, the inclination resistance can be calculated. When adapting the injection quantity associated with the idling torque to the driving resistance, for example a traction upshift, while driving uphill under heavy load takes place more rapidly than while driving along a flat stretch with a low load.

However, the current operating condition of the motor vehicle is also determined by the operating status of the drive engine. For example, in the case of combustion engines with a turbocharger, it is important for the speed of the drive engine not to decrease too much during the shift operation, otherwise the load build-up, due to the necessary acceleration of the exhaust gas turbine and hence the shift operation as a whole, takes a particularly long time. It is, therefore, expedient to determine the acceleration capacity of the drive engine at the beginning of the shift operation and, in relation to an average acceleration capacity, to decrease the injection quantity of the drive engine associated with the idling torque if the acceleration capacity is greater or to increase it if the acceleration capacity is smaller. The acceleration capacity of the drive engine can be calculated from the speed of the drive engine at the time, the current charge pressure of the drive engine and the torque of the drive engine at the time, the corresponding values are determined by sensors or read out of the engine control unit.

The power demand by the driver can also be regarded as a further operating parameter. It is, therefore, expedient to determine the power demand by the driver and, in relation to an average power demand, to increase the injection quantity of the drive engine if the power demand is greater or decrease it if the power demand is smaller.

The driver's power demand can be detected or deduced from the position of the accelerator pedal which can be determined by a path sensor, from the actuation of a kick-down switch when the accelerator pedal is fully depressed and, correspondingly, when the power demand is negative from the actuation of the service brakes that can be determined by virtue of a brake pedal switch.

Independent of any direct operation by the driver, an interrogation can distinguish which driving program is active as between an economical or a sporty setting or a summer or winter setting and the optimum injection quantity can be set appropriately for this.

Likewise, a shift operation is influenced substantially by transmission- and shift-specific shift parameters. Accordingly, the injection quantity associated with the idling torque is expediently also modified as a function of the transmission ratio change of the shift process envisaged, depending on the load direction during the shift process, and depending on the shift direction of the shift process.

In each case, the ratio change is determined by design and can usually be read out from an electronic memory. The injection quantity of the drive engine, associated with the idling torque relative to an average ratio change, is increased if the ratio change is larger and reduced if the ratio change is smaller such that, in either case, a shift operation of approximately the same length can be achieved.

Superimposed over this, to assist the load build-up, the injection quantity of the drive engine associated with the idling torque should be increased during a traction shift and reduced during a thrust shift and to assist the speed adaptation, reduced during an upshift and increased during a downshift.

### BRIEF DESCRIPTION OF THE DRAWINGS

The invention will now be described, by way of example, with reference to the accompanying drawings in which:

The sole FIGURE shows the variations of the regulating path of the engine clutch, the injection quantity of the drive engine and the torque of the drive engine during a traction shift in a time diagram.

### DETAILED DESCRIPTION OF THE INVENTION

In this time diagram, for the end of a shift process with the engine clutch disengaged considered as an example, a variation of a regulating path S_{K} of the engine clutch, a variation of an injection amount α_{ME} and a variation of a torque M_{M} of the drive engine controlled by the injection amount α_{ME} of the drive engine are shown as a function of time t.

At time point t0, the target gear is engaged and the injection amount α_{ME} is, in a normal case, reduced to a value α0a associated with an idling torque M0a. Consequently, the torque M_{M} of the drive engine is close to zero at the value M0a. The engine clutch is in a disengaged or fully open position s0. At time point t1, the load build-up of the drive engine is started by a ramp-shaped increase of the injection amount α_{ME} from the value α0a to a value α1, which is reached at a time t2a. Correspondingly, between t1 and t2a, the torque M_{M} increases in coordination with the engagement of the engine clutch (clutch path S_{K} increases from position s0 to position s1) from the value M0a to a value M1. Thus, the shift operation takes up the interval t2a−t1.

If this interval t2a−t1 is too long, because of unfavorable operating conditions, then according to the invention the reduced injection amount α_{ME} of the drive engine is increased at the beginning of a shift operation to a value α0b, whereby the torque M_{M} of the drive engine too is increased slightly to a value M0b. As a result, with the same gradient of the injection amount α_{ME}, the target value α1 during load build-up is reached earlier, namely at a time point t2b. In this case, since the engine clutch follows the load build-up of the drive engine during the shift process, the clutch path S_{K} also reaches the engaged position s1 at time point t2b. Thus, the load build-up of the drive engine and the engagement process of the engine clutch now take place during a shorter interval t2b−t1, so the entire shift process is faster.

### REFERENCE NUMERALS

M_{M} torque of the drive engine
M0a idling torque, initial value of M_{M}
M0b idling torque, initial value of M_{M}
M1 torque under load, target value of M_{M}
S_{K} regulation path of the engine clutch
s0 path position of S_{K}, engine clutch disengaged
s1 path position of S_{K}, engine clutch engaged
α_{ME} fuel injection quantity of the drive engine
α0a initial value of α_{ME}
α0b initial value of α_{ME}
α1 target value of α_{ME}
t time
t0 time point
t1 time point
t2a time point
t2b time point

1-10. (canceled)

11. A shift control method for an automated motor vehicle transmission, which is connected on an input side to a drive engine by an engine clutch, the drive engine being provided with an electronically controllable fuel injection such that during a gear shift operation between a gear under load and a target gear, before the loaded gear is disengaged, a torque (M_{M}) of the drive engine is adjusted to an idling torque by modification of an amount of a fuel injected (α_{ME}) and, after the target gear has been engaged, to a load torque by a converse modification of the injection amount, the method comprising the steps of:
detecting and evaluating, at a beginning of the shift operation at least one an operating parameter that characterizes a current operating condition of the motor vehicle and a shift parameter that characterizes the shift operation envisaged, and variably adapting the injection amount (α0a) of the drive engine associated with the idling torque to at least one of the operating condition of the motor vehicle and to the shift operation as a function of a result of the evaluation, determining a driving resistance of the motor vehicle, and, in relation to an average driving resistance, increasing the injection amount (α0a) of the drive engine if the driving resistance is larger and reducing injection amount (α0a) of the drive engine if the driving resistance is smaller.

12. The method according to claim 11, further comprising the step of determining a weight of the vehicle by a loading sensor and calculating a rolling resistance therefrom, determining a driving speed by a speed sensor and calculating an air resistance therefrom, and determining a road inclination by an inclination sensor and calculating an inclination resistance therefrom.

13. The method according to claim 11, further comprising the step of determining an acceleration capacity of the drive engine and, in relation to an average acceleration capacity, decreasing an injection quantity (α0a) associated with the idling torque of the drive engine if an acceleration capacity is larger and increasing the injection quantity (α0a) if the acceleration capacity is smaller.

14. The method according to claim 13, further comprising the step of determining at least one of the speed of the drive engine by at least one of a speed sensor and a charge pressure of the drive engine by a pressure sensor and torque of the drive engine by a torque sensor, and calculating an acceleration capacity of the drive engine therefrom.

15. The method according to claim 11, further comprising the step of determining a driver's power demand and, in relation to an average power demand, increasing the injection quantity (α0a) associated with the idling torque when the power demand is greater, and reducing the injection quantity (α0a) when the power demand is smaller.

16. The method according to claim 15, further comprising the step of determining at least one of an accelerator pedal position by a path sensor, an end position of the accelerator pedal by a kick-down switch, an actuation of a service brake by a brake pedal switch, a driving program activated by a driving program switch, and deducing a driver's power demand therefrom.

17. The method according to claim 11, further comprising the step of determining a transmission ratio change between the gear under load and the target gear and, relative to an average ratio change, increasing the injection amount (α0a) of the drive engine associated with the idling torque if the ratio change is larger and reducing the injection amount (α0a) of the drive engine if the ratio change is smaller.

18. The method according to claim 11, further comprising the step of determining a load direction of the drive train, and increasing the injection quantity (α0a) associated with the idling torque for a traction shift and reducing the injection quantity (α0a) associated with the idling torque for a thrust shift.

19. The method according to claim 11, further comprising the step of determining a shift direction of the shift operation, and reducing the injection quantity (α0a) of the drive engine for an upshift and increasing the injection quantity (α0a) of the drive engine for a downshift.

20. A method of controlling gear shifting in an automated motor vehicle transmission, which is connected, via an automated friction clutch, to an internal combustion engine provided with electronically controllable fuel injection system, the method comprising the steps of:
indicating a desire to shift gear ratios from a current gear ratio to a desired gear ratio;
adjusting engine torque to an idling torque;
defining driving resistance of the motor vehicle as one of current operating parameters;
detecting and determining at least one of the current operating parameters and shift parameters, the current operating parameters characterizing current operating conditions of the motor vehicle and the shift parameters, characterizing the desired gear ratio shift;
disengaging the current gear ratio;
comparing the at least one of the current operating parameters to an average of the at least one of the current operating parameters;
comparing the at least one of the shift parameters to an average of the at least one of the shift parameters;
engaging the desired gear ratio; and
adjusting the engine torque from the idling torque to a load torque by modifying a volume of a fuel injected by the fuel injection system depending on the comparison between the at least one of the current operating parameters and shift parameters and the average of the at least one of the current operating parameters and the average of the at least one of the shift parameters.

21. The method according to claim 20, further comprising the steps defining a driving resistance as one of the current operating parameters;
increasing the volume of the fuel injected if the driving resistance is greater than an average of the driving resistance; and
decreasing the volume of the fuel injected if the driving resistance is less than the average of the driving resistance.

22. The method according to claim 21, further comprising the steps of determining a laden weight of the vehicle by a loading sensor and calculating rolling resistance therefrom;
determining a driving speed by a speed sensor and calculating air resistance therefrom;
determining road inclination by an inclination sensor and calculating inclination resistance therefrom; and
defining the driving resistance of the motor vehicle as at least one of the rolling resistance, the air resistance and the inclination resistance.

23. The method according to claim 21, further comprising the steps of defining acceleration capacity of the drive engine as one of the current operating parameters and the shift parameters;
reducing the volume of the fuel injected if the acceleration capacity is larger than an average of the acceleration capacity; and
increasing the volume of the fuel injected if the acceleration capacity is smaller than an average of the acceleration capacity.

24. The method according to claim 23, further comprising the steps of determining at least one of a speed of the drive engine by a speed sensor, a charge pressure of the drive engine by a pressure sensor, the torque of the drive engine by a torque sensor, and calculating an acceleration capacity of the drive engine therefrom.

25. The method according to claim 20, further comprising the steps of defining a driver's power demand as one of the current operating parameters and the shift parameters;
increasing the volume of the fuel injected if the driver's power demand is greater than an average power demand; and
reducing the volume of the fuel injected if the driver's power demand is smaller than an average power demand.

26. The method according to claim 25, further comprising the steps of at least one of determining an accelerator pedal position by a path sensor, an end position of the accelerator pedal by a kick-down switch, actuation of a service brake by a brake pedal switch and a driving program activated by a driving program switch and determining the driver's power demand therefrom.

27. The method according to claim 21, further comprising the steps of determining a transmission ratio change between the current gear ratio and the desired gear ratio; and
increasing the volume of the fuel injected if the transmission ratio change is larger than an average transmission gear ratio change; and
decreasing the volume of the fuel injected if the transmission ratio change is smaller than an average transmission gear ratio change.

28. The method according to claim 20, further comprising the steps of determining a load direction of the drivetrain;
increasing the volume of the fuel injected if the load direction indicates a traction shift; and
decreasing the volume of the fuel injected if the load direction indicates a thrust shift.

29. The method according to claim 20, further comprising the steps of determining a load direction of the drivetrain;
increasing the volume of the fuel injected if the load direction indicates a downshift; and
decreasing the volume of fuel injected if the load direction indicates an upshift.
